(19) United States
(12) Patent Application Publication
(10) Pub. No.: US 2025/0075945 A1
(43) Pub. Date: Mar. 6, 2025

(54) CONTROL METHOD AND DEVICE FOR PHASE-CHANGE ENERGY STORAGE TYPE COLD AND HEAT COMBINED SUPPLY SYSTEM WITH MULTI-HEAT SOURCE HEAT PUMP

(71) Applicants: STATE GRID JIANGSU ELECTRIC POWER CO., LTD NANJING POWER SUPPLY COMPANY, Jiangsu (CN); NANJING JIANGBEI NEW AREA PUBLIC UTILITIES HOLDING GROUP CO.LTD, Jiangsu (CN)

(72) Inventors: Dongxu ZHOU, Jiangsu (CN); Shengyu GAO, Jiangsu (CN); Kefei FAN, Jiangsu (CN); Jiahua XIA, Jiangsu (CN); Jing XU, Jiangsu (CN); Lin MA, Jiangsu (CN); Zhengdong LIANG, Jiangsu (CN); Hengjun ZHOU, Jiangsu (CN); Hui WU, Jiangsu (CN); Weiya ZHANG, Jiangsu (CN)

(73) Assignees: STATE GRID JIANGSU ELECTRIC POWER CO., LTD NANJING POWER SUPPLY COMPANY, Jiangsu (CN); NANJING JIANGBEI NEW AREA PUBLIC UTILITIES HOLDING GROUP CO.LTD, Jiangsu (CN)

(21) Appl. No.: 18/495,760

(22) Filed: Oct. 27, 2023

(30) Foreign Application Priority Data
Sep. 1, 2023 (CN) 202311127267.2

(51) Int. Cl. F24S 50/40; F24S 20/40; F24S 60/10

(52) U.S. Cl. CPC F24S 50/40; F24S 20/40; F24S 60/10

(57) ABSTRACT

A control method for a phase-change energy storage type cold and heat combined supply system with a multi-heat source heat pump includes the following steps of: recording the temperature of a solar panel using solar energy as a heat source at a certain moment as tₜ, the temperature of a water source to be taken as tₛ, the temperature of a geothermal source as t_{d}, the temperature of an air source as tₖ; calculating the heat storage efficiency ζₛ, ζₖ and ζ_{d} of the phase change material under the action of solar energy-water energy, solar energy-air source and solar energy-ground source; calculating the hourly heat storage capacity of the heat pump Q_{rb}, comparing it with the total hourly heat consumption of the system Qₜₒₗ, and if Q_{rb}<1.45Qₜₒₗ, regulating the use of various heat sources through the heat storage integrated regulation system until Q_{rb}<1.45Qₜₒₗ.

### CROSS-REFERENCE TO RELATED APPLICATION

This application claims the priority benefit of China application serial no. 202311127267.2, filed on Sep. 1, 2023. The entirety of the above-mentioned patent application is hereby incorporated by reference herein and made a part of this specification.

### TECHNICAL FIELD

The present invention relates to the technical field of optimal configuration of an energy storage system and particularly relates to a control method and device for a phase-change energy storage type cold and heat combined supply system with a multi-heat source heat pump.

### BACKGROUND

The current energy consumption is huge, especially the transitional use of fossil energy, while primary energy is scarce and the environment is seriously damaged. Under the initiative of carbon peaking and carbon neutrality goals, the energy industry is gradually turning to a clean, low-carbon, and environmentally friendly type. Facing the severe challenges of huge energy consumption and environmental problems, it is urgent to actively develop energy-saving and emission-reduction technologies, explore new green renewable energy interaction modes, and promote the upgrading of the green and healthy energy industry. However, renewable energy has very strong volatility and intermittency, such as wind energy and solar energy are very vulnerable to the influence of time and place, so the degree of energy instability is high, and its rules are difficult to master, so it is very difficult to achieve the full and effective use of a single renewable energy.

As a frontier technology in the field of energy, the cold and heat combined supply system is based on the cascade utilization of energy, which integrates cooling and heating and helps to reduce the emission of pollutant gases. It is an efficient energy supply method, so it is widely used in the building energy supply of green factories and green industrial parks in various regions. The heat pump functions similarly to the water pump and can transfer heat energy stored in a low-grade heat source to a high-grade heat source, wherein the low-grade heat source includes natural air, water, soil ground heat, etc. and the high-grade heat source is heat that can be used by people, such as city heating, crop irrigation, etc. A phase change material (PCM) refers to a substance that changes the state of a substance at a constant temperature and provides latent heat. Phase-change energy storage generally refers to the use of a phase-change material to store energy with a certain device during the phase-change process and to release thermal energy when there is a need. Therefore, the combination of phase change materials and heat pumps is an efficient means of energy utilization, which is of great significance for the realization of national energy strategic transformation and new urban and rural green construction, and also provides a good opportunity for the development of the energy storage industry.

According to the search in the prior art, it is found that the Chinese application CN113790469A “a cold and heat combined supply system for a heating reactor with heat storage and peak regulation function and method for operating the same” discloses a solution which takes into account the changing characteristics of the cooling and heating load in different seasons and at different times during the day, and achieves the heat storage and peak regulation within the day and across seasons; however, the patent uses a single heat source, and has insufficient reliability in heat storage and heating, and at the same time has a complicated structure and a high control cost. The solution disclosed in the Chinese application CN114739029A “multipurpose carbon dioxide heat pump cold and heat combined supply system” is to switch an air cooler mode and an evaporator mode in the same heat exchanger so as to solve the problem of mismatch between cooling capacity and heat capacity; however, the solution uses an air-liquid as a heat storage material, and the heat storage effect is poor, and carbon dioxide has very high critical pressure and a very low critical temperature, which makes the design of system components very difficult.

The cold and heat combined supply system is one of the core technologies of the micro-energy grid. In summary, in the application of the existing technology in the micro-energy grid, there are many problems such as a single heat source, poor heat storage, poor heating effect, and poor reliability.

### SUMMARY OF THE DISCLOSURE

The present invention provides a control method and device for a phase-change energy storage type cold and heat combined supply system with a multi-heat source heat pump, achieving efficient cooperation among multiple energy sources, and achieving the purpose of improving the operating efficiency of a micro-energy grid.

The present invention specifically uses the following technical solution:

A control method for a phase-change energy storage type cold and heat combined supply system with a multi-heat source heat pump, wherein heat sources of the multi-heat source heat pump includes solar energy-water energy, solar energy-air source, and solar energy-ground source, the control method comprises the following steps of:

Step a: recording the temperature of a solar panel using solar energy as a heat source at a certain moment as tₜ, the temperature of a water source to be taken as tₛ, the temperature of a geothermal source as t_{d}, the temperature of an air source as tₖ, and the temperature of the phase change material before heat storage as t₁, the temperature of the phase change material of the heat pump system after heat storage only under the action of solar energy-water energy as t₂, the temperature of the phase change material of the heat pump system after heat storage only under the action of solar energy-air source as t₃, and the temperature of the phase change material of the heat pump system after heat storage only under the action of solar energy-ground source as t₄;

Step b: calculating the heat storage efficiency ζₛ, ζₖ and ζ_{d} of the phase change material under the action of solar energy-water energy, solar energy-air source, and solar energy-ground source, specifically:

$${ζ}_{s} = {ρ}_{1} \vert \frac{{t}_{2} - {t}_{1}}{{t}_{t} - {t}_{s}} \vert$$

$${ζ}_{k} = {ρ}_{2} \vert \frac{{t}_{3} - {t}_{1}}{{t}_{t} - {t}_{k}} \vert$$

$${ζ}_{d} = {ρ}_{3} \vert \frac{{t}_{4} - {t}_{1}}{{t}_{t} - {t}_{d}} \vert$$

wherein, ρ₁, ρ₂ and ρ₃ are respectively referred to as a water source, an air source, and a geothermal source heat regulation coefficient;

Step c: calculating hourly heat storage capacity of heat pump Q_{rb}:

$${Q}_{rb} = {ζ}_{s} ( {n}_{s} {p}_{s} {Q}_{p} ) + {ζ}_{k} ( {n}_{k} {p}_{k} {Q}_{w} ) + {ζ}_{d} {I}_{γ} ( {n}_{d} {p}_{d} {Q}_{r} ) + {Q}_{WA}$$

In the above formula, nₛ is the number of water intake pipes, pₛ is the flow area of water collecting pipes, and Qₚ is the hourly heat collecting capacity of a single water tank; nₖ is the number of gas collecting pipes, pₖ is the effective gas collecting area of the gas collecting pipes, and Q_{w} is the hourly heat collecting capacity of a single gas box; n_{d} is the number of geothermal source collection devices, pa is the effective heat collecting area, I_{γ} is the solar radiation intensity, Qᵣ is hourly ground heat collecting capacity; Q_{WA} is hourly heat output of the heat pump;
comparing the hourly heat output of the heat pump with the total hourly heat consumption of the system Qₜᵣₒₗ, and if Q_{rb}<1.45Qₜₒₗ, regulating the use of various heat sources through the heat storage integrated regulation system until Q_{rb}≥1.45Qₜₒₗ.

Furthermore, the difference adjustment coefficients ρ₁, ρ₂, and ρ₃ of the Step b satisfy:

$${ρ}_{1} = \frac{Δ {t}_{s}}{\overline{{t}_{s}}} \cdot \frac{Δ {v}_{s}}{\overline{{v}_{s}} + \overline{w}}$$

$${ρ}_{2} = \frac{Δ {t}_{k}}{\overline{{t}_{k}}} \overline{w} \%$$

$${ρ}_{3} = \frac{Δ {t}_{d}}{\overline{{t}_{d}}}$$

wherein, Δtₛ and Δvₛ are the temperature difference and flow rate difference of the water source within any 10 minutes, t̅ₛ̅ and v̅ₛ̅ are the average temperature and average flow rate of the water source within a day, and w̅ is the average wind speed; Δtₖ is the temperature difference within any 3 hours, t̅ₖ̅ is the average temperature within a day; Δt_{d} is the geothermal temperature difference within any one hour, t̅_̅{̅d̅}̅ is the average geothermal temperature within a day.

Further, in the Step c, the regulating use of various heat sources through a heat storage integrated regulation system is: in an initial state, the flow area of the water collecting pipe pₛ, the effective gas collecting area of the gas collecting pipe pₖ and the effective heat collecting area of the solar panel pa are all set to ½ of the maximum value; in response to the hourly heat storage capacity Q_{rb}<1.45Qₜₒₗ, comparing the magnitudes of ζₛ, ζₖ, and ζ_{d} at that time, reducing the collecting area of the heat source with the minimum heat storage efficiency to 40% of the original level, increasing the collecting area of the heat source with the maximum heat storage efficiency to 120% of the original level, and recalculating the hourly heat storage capacity Q_{rb}; at the same time, compared with the hourly total heat consumption of the system Qₜₒₗ, if the hourly heat storage capacity Q_{rb} is still less than 1.45Qₜₒₗ, a PID-based control algorithm is used to regulate a flow area of the water collecting pipe pₛ, an effective gas collecting area of the gas collecting pipe pₖ, and an effective heat collecting area of the solar panel pa, so that a heat storage of the heat pump for each hour finally satisfies the hourly heat storage capacity Q_{rb}=1.45Qₜₒₗ.

Further, the PID-based control algorithm is specifically:
the algorithm takes the flow area of the water collecting pipe pₛ, the effective gas collecting area of the gas collecting pipe pₖ, and the effective heat collecting area of the solar panel Pa as control variables and the hourly heat storage capacity Or as an output variable, and each sampling time is set to one hour, then at the k^{th} hour, the difference 1.45Qₜₒₗ−Q_{rb} (k) between the target value of the output 1.45Qₜₒₗ and the heat storage capacity of the heat pump Q_{rb}(k) at the k^{th} hour is called deviation e(k), and continuously adjusting the magnitude of pₛ, pₖ, and p_{d} by using the following formula, so that the hourly heat storage capacity of the heat pump Q_{rb} is finally equal to 1.45Qₜₒₗ that after multiple iterations:

$${Q}_{rb} = {K}_{p} e ( k ) + {K}_{i} {\sum }_{n = 0}^{k} e ( n ) + {K}_{d} ( e ( k ) - e ( k - 1 ) )$$

In the above formula, Kₚ is the proportion coefficient, and taking 0.5pₛ; Kᵢ is the integral time constant, and taking 0.7pₖ; K_{d} is the differential time constant, taking 0.65p_{d} and e (0)=0.

Further, the phase change material is a mixed material of industrial-grade acetamide (CAS: 79-07-2) and natural renewable grease.

A control device for a phase-change energy storage type cold and heat combined supply system with a multi-heat source heat pump is configured to execute the above control method for the phase-change energy storage type cold and heat combined supply system with a multi-heat source heat pump, comprising an acquisition and detection module, a control module, a modulation algorithm module, an integrated compensation module, and a heat pump and cold and heat combined supply system;
the acquisition and detection module is configured to execute speed acquisition, temperature acquisition, and thermal energy acquisition, and transmit the acquired data to the control module; the modulation algorithm module is connected to the control module, and configured to analyze the acquired data by the acquisition and detection module and calculate to obtain the hourly heat storage capacity of the heat pump Q_{rb}; while the integrated compensation module is connected to the control module, and connected to the heat pump and the cold and heat combined supply system together with the control module; the operation steps are as follows:
a. making the device start to operate, and detecting various indexes of wind speed, water flow rate, air temperature, water temperature, and geothermal temperature by electric detection of the acquisition and detection module, and transmitting the data to the control module;
b. analyzing the acquired data using the control module through the modulation algorithm module, and at the same time controlling the integrated compensation module to adjust the collecting area of various types of heat sources;
c. sending a regulation instruction to the heat pump to complete optimization and control of the cold and heat combined supply system.

The present invention has the following advantageous effects:
the present invention achieves rational coordination of three heat sources through a mixed phase change material of industrial-grade acetamide and natural renewable grease and achieves maximum heat storage of a heat pump by adjusting the acquisition capacity of the other two heat sources when a certain heat source fluctuates greatly, and the method has strong anti-interference ability, simple operation, and low cost. The coordination of the heat source collecting area is realized through the PID control algorithm. The advantages of the PID algorithm are that it can quickly and stably converge to the target value of heat pump heat storage, with high control precision and strong anti-interference ability.

### BRIEF DESCRIPTION OF THE DRAWINGS

FIG. 1 is a flow chart of a control method for a phase-change energy storage type cold and heat combined supply system with a multi-heat source heat pump according to the present invention;

FIG. 2 is a structural diagram of a control device for a phase-change energy storage type cold and heat combined supply system with a multi-heat source heat pump according to the present invention.

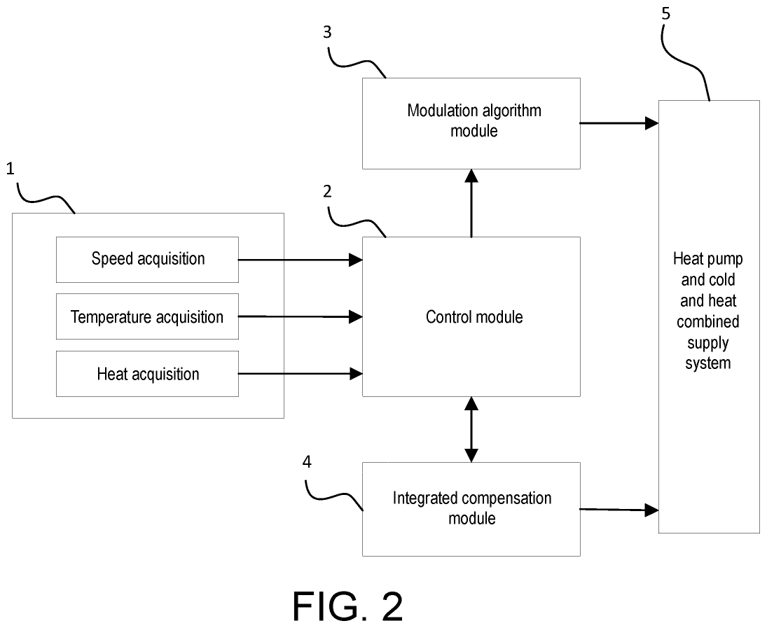

In FIG. 2:1. An acquisition and detection module; 2. A control module; 3. A modulation algorithm module; 4. An integrated compensation module; 5. Heat pump and cold and heat combined supply system.

### DETAILED DESCRIPTION OF THE DISCLOSURE

The will now be made in detail to the embodiments of the present invention, examples of which are illustrated in the accompanying drawings. It is to be understood that the present invention may be embodied in other specific forms without departing from the spirit or scope of the invention. Based on the embodiments of the present invention, all other embodiments obtained by a person of ordinary skill in the art without inventive effort fall within the scope of the present invention.

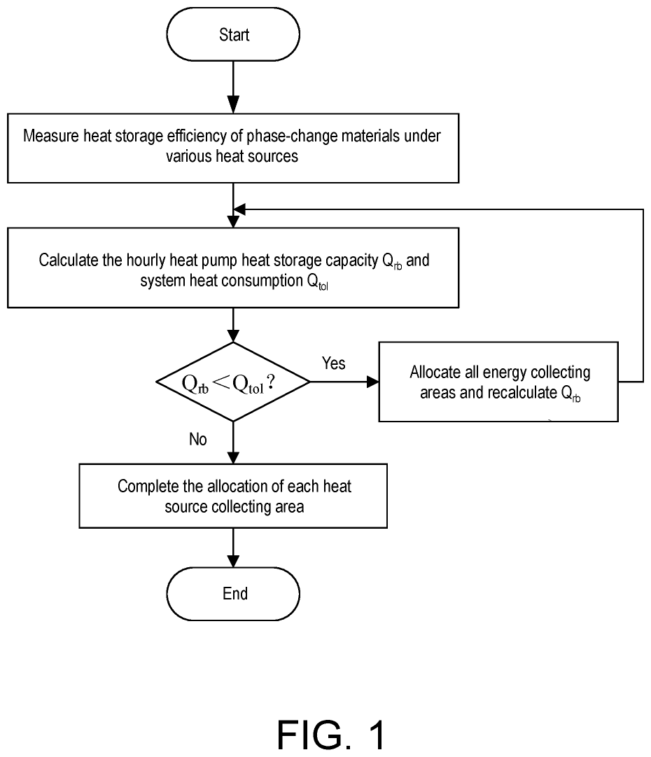

With reference to FIG. 1, a control method for a phase-change energy storage type cold and heat combined supply system with a multi-heat source heat pump, wherein heat sources of the multi-heat source heat pump includes solar energy-water energy, solar energy-air source and solar energy-ground source so as to achieve efficient cooperation among various energy sources and achieve the purpose of improving the operating efficiency of a micro-energy grid, the control method comprises the following steps of:

Step a: recording the temperature of a solar panel using solar energy as a heat source at a certain moment as tₜ, the temperature of a water source to be taken as tₛ, the temperature of a geothermal source as t_{d}, the temperature of an air source as tₖ, and the temperature of the phase change material before heat storage as t₁, the temperature of the phase change material of the heat pump system after heat storage only under the action of solar energy-water energy as t₂, the temperature of the phase change material of the heat pump system after heat storage only under the action of solar energy-air source as t₃, and the temperature of the phase change material of the heat pump system after heat storage only under the action of solar energy-ground source as t₄; The phase change material is a mixed material of industrial-grade acetamide (CAS: 79-07-2) and natural renewable grease.

Step b: calculating the heat storage efficiency ζₛ, ζₖ and ζ_{d} of the phase change material under the action of solar energy-water energy, solar energy-air source, and solar energy-ground source, specifically:

$${ζ}_{s} = {ρ}_{1} \vert \frac{{t}_{2} - {t}_{1}}{{t}_{t} - {t}_{s}} \vert$$

$${ζ}_{k} = {ρ}_{2} \vert \frac{{t}_{3} - {t}_{1}}{{t}_{t} - {t}_{k}} \vert$$

$${ζ}_{d} = {ρ}_{3} \vert \frac{{t}_{4} - {t}_{1}}{{t}_{t} - {t}_{d}} \vert$$

wherein, ρ₁, ρ₂ and ρ₃ are respectively referred to as a water source, an air source, and a geothermal source heat regulation coefficient;

The difference adjustment coefficients ρ₁, ρ₂, and ρ₃ satisfy:

$${ρ}_{1} = \frac{Δ {t}_{s}}{\overline{{t}_{s}}} \cdot \frac{Δ {v}_{s}}{\overline{{v}_{s}} + \overline{w}}$$

$${ρ}_{2} = \frac{Δ {t}_{k}}{\overline{{t}_{k}}} \overline{w} \%$$

$${ρ}_{3} = \frac{Δ {t}_{d}}{\overline{{t}_{d}}}$$

wherein, Δtₛ and Δvₛ are the temperature difference and flow rate difference of the water source within any 10 minutes, t̅ₛ̅ and v̅ₛ̅ are the average temperature and average flow rate of the water source within a day, and w̅ is the average wind speed; Δtₖ is the temperature difference within any 3 hours, t̅ₖ̅ is the average temperature within a day; Δt_{d} is the geothermal temperature difference within any one hour, t̅_̅{̅d̅}̅ is the average geothermal temperature within a day.

Step c: calculating hourly heat storage capacity of heat pump Q_{rb}:

$${Q}_{rb} = {ζ}_{s} ( {n}_{s} {p}_{s} {Q}_{p} ) + {ζ}_{k} ( {n}_{k} {p}_{k} {Q}_{w} ) + {ζ}_{d} {I}_{γ} ( {n}_{d} {p}_{d} {Q}_{r} ) + {Q}_{WA}$$

In the above formula, nₛ is the number of water intake pipes, pₛ is the flow area of water collecting pipes, and Qₚ is the hourly heat collecting capacity of a single water tank; nₖ is the number of gas collecting pipes, pₖ is the effective gas collecting area of the gas collecting pipes, and Q_{w} is the hourly heat collecting capacity of a single gas box; n_{d} is the number of geothermal source collection devices, p_{d} is the effective heat collecting area, I_{γ} is the solar radiation intensity, Qᵣ is hourly ground heat collecting capacity; Q_{WA} is hourly heat output of the heat pump;
comparing the hourly heat output of the heat pump with the total hourly heat consumption of the system Qₜₒₗ, and if Q_{rb}<1.45 Qₜₒₗ, regulating the use of various heat sources through the heat storage integrated regulation system until Q_{rb}>1.45 Qₜₒₗ.

In the Step c, the regulating use of various heat sources through a heat storage integrated regulation system is: in an initial state, the flow area of the water collecting pipe pₛ, the effective gas collecting area of the gas collecting pipe pₖ and the effective heat collecting area of the solar panel p_{d} are all set to ½ of the maximum value; in response to the hourly heat storage capacity Q_{rb}<1.45 Qₜₒₗ, comparing the magnitudes of ζₛ, ζₖ, and ζ_{d} at that time, reducing the collecting area of the heat source with the minimum heat storage efficiency to 40% of the original level, increasing the collecting area of the heat source with the maximum heat storage efficiency to 120% of the original level, and recalculating the hourly heat storage capacity Q_{rb}; at the same time, compared with the hourly total heat consumption of the system Qₜₒₗ, if the hourly heat storage capacity Q_{rb} is still less than 1.45 Qₜₒₗ, a PID-based control algorithm is used to regulate a flow area of the water collecting pipe pₛ, an effective gas collecting area of the gas collecting pipe pₖ, and an effective heat collecting area of the solar panel p_{d}, so that a heat storage of the heat pump for each hour finally satisfies the hourly heat storage capacity Q_{rb}=1.45Qₜₒₗ.

It should be understood that the collecting area is the flow area of the above-mentioned water collecting pipe pₛ, the effective gas collecting area of the gas collecting pipe pₖ, or the effective heat collecting area of the solar panel p_{d}.

The PID-based control algorithm is specifically:
the algorithm takes the flow area of the water collecting pipe pₛ, the effective gas collecting area of the gas collecting pipe pₖ, and the effective heat collecting area of the solar panel p_{d} as control variables and the hourly heat storage capacity Q_{rb} as an output variable, and each sampling time is set to one hour, then at the k^{th} hour, the difference 1.45Qₜₒₗ−Q_{rb}(k) between the target value of the output 1.45Qₜₒₗ and the heat storage capacity of the heat pump Q_{rb} (k) at the k^{th} hour is called deviation e(k), and continuously adjusting the magnitude of pₛ, pₖ, and p_{d} by using the following formula, so that the hourly heat storage capacity of the heat pump Q_{rb} is finally equal to 1.45Qₜₒₗ that after multiple iterations:

$${Q}_{rb} = {K}_{p} e ( k ) + {K}_{i} {\sum }_{n = 0}^{k} e ( n ) + {K}_{d} ( e ( k ) - e ( k - 1 ) )$$

In the above formula, Kₚ is the proportion coefficient, and taking 0.5pₛ; Kᵢ is the integral time constant, and taking 0.7pₖ; K_{d} is the differential time constant, taking 0.65p_{d} and e (0)=0.

With reference to FIG. 2, a control device for a phase-change energy storage type cold and heat combined supply system with a multi-heat source heat pump is configured to execute the above control method for the phase-change energy storage type cold and heat combined supply system with a multi-heat source heat pump, comprising an acquisition and detection module, a control module, a modulation algorithm module, an integrated compensation module and a heat pump and cold and heat combined supply system.

The acquisition and detection module is configured to execute speed acquisition, temperature acquisition, and thermal energy acquisition, and transmit the acquired data to the control module; the modulation algorithm module is connected to the control module, and configured to analyze the acquired data by the acquisition and detection module and calculate to obtain the hourly heat storage capacity of the heat pump Q_{rb}; while the integrated compensation module is connected to the control module, and connected to the heat pump and the cold and heat combined supply system together with the control module; the operation steps are as follows:
a. making the device start to operate, and detecting various indexes of wind speed, water flow rate, air temperature, water temperature, and geothermal temperature by electric detection of the acquisition and detection module, and transmitting the data to the control module;
b. analyzing the acquired data using the control module through the modulation algorithm module, and at the same time controlling the integrated compensation module to adjust the collecting area of various types of heat sources;
c. sending a regulation instruction to the heat pump to complete optimization and control of the cold and heat combined supply system.

What is claimed is:

1. A control method for a phase-change energy storage type cold and heat combined supply system with a multi-heat source heat pump, wherein heat sources of the multi-heat heat pump includes solar energy-water energy, solar energy-air source, and solar energy-ground source, the control method comprises the following steps of:
step a: recording the temperature of a solar panel using solar energy as a heat source at a certain moment as tₜ, the temperature of a water source to be taken as tₛ, the temperature of a geothermal source as t_{d}, the temperature of an air source as tₖ, and the temperature of a phase change material before heat storage as t₁, the temperature of the phase change material of the heat pump system after heat storage only under the action of solar energy-water energy as t₂, the temperature of the phase change material of the heat pump system after heat storage only under the action of solar energy-air source as t₃, and the temperature of the phase change material of the heat pump system after heat storage only under the action of solar energy-ground source as t₄;
step b: calculating the heat storage efficiency ζₛ, ζₖ and ζ_{d} of the phase change material under the action of solar energy-water energy, solar energy-air source, and solar energy-ground source, specifically:
$${ζ}_{s} = {ρ}_{1} \vert \frac{{t}_{2} - {t}_{1}}{{t}_{t} - {t}_{s}} \vert$$
$${ζ}_{k} = {ρ}_{2} \vert \frac{{t}_{3} - {t}_{1}}{{t}_{t} - {t}_{k}} \vert$$
$${ζ}_{d} = {ρ}_{3} \vert \frac{{t}_{4} - {t}_{1}}{{t}_{t} - {t}_{d}} \vert$$
wherein, ρ₁, ρ₂, and ρ₃ are respectively referred to as a water source, an air source, and a geothermal source heat regulation coefficient;
step c: calculating hourly heat storage capacity of the heat pump Q_{rb}:
$${Q}_{rb} = {ζ}_{s} ( {n}_{s} {p}_{s} {Q}_{p} ) + {ζ}_{k} ( {n}_{k} {p}_{k} {Q}_{w} ) + {ζ}_{d} {I}_{γ} ( {n}_{d} {p}_{d} {Q}_{r} ) + {Q}_{WA}$$
wherein nₛ is the number of water intake pipes, pₛ is a flow area of water collecting pipes, and Qₚ is an hourly heat collecting capacity of a single water tank; nₖ is the number of gas collecting pipes, pₖ is an effective gas collecting area of the gas collecting pipes, and Q_{w} is an hourly heat collecting capacity of a single gas box; n_{d} is the number of geothermal source collection devices, p_{d} is an effective heat collecting area, I_{γ} is a solar radiation intensity, Qᵣ is an hourly ground heat collecting capacity; Q_{WA} is an hourly heat output of the heat pump; and
comparing with a total hourly heat consumption of the system Qₜₒₗ, and if Q_{rb}<1.45Qₜₒₗ, regulating use of various heat sources through a heat storage integrated regulation system until Q_{rb}≥1.45Qₜₒₗ.

2. The control method for the phase-change energy storage type cold and heat combined supply system with a multi-heat source heat pump of claim 1, wherein the difference adjustment coefficients ρ₁, ρ₂, and ρ₃ of the step b satisfy:
$${ρ}_{1} = \frac{Δ {t}_{s}}{\overline{{t}_{s}}} \cdot \frac{Δ {v}_{s}}{\overline{{v}_{s}} + \overline{w}}$$
$${ρ}_{2} = \frac{Δ {t}_{k}}{\overline{{t}_{k}}} \overline{w} \%$$
$${ρ}_{3} = \frac{Δ {t}_{d}}{\overline{{t}_{d}}}$$
wherein, Δtₛ and Δvₛ are a temperature difference and a flow rate difference of the water source within any 10 minutes, t̅ₛ̅ and v̅ₛ̅ are an average temperature and an average flow rate of the water source within a day, and w̅ is an average wind speed; Δtₖ is a temperature difference within any 3 hours, t̅ₖ̅ is an average temperature within a day; Δt_{d} is a geothermal temperature difference within any one hour, t̅_̅{̅d̅}̅ is an average geothermal temperature within a day.

3. The control method for the phase-change energy storage type cold and heat combined supply system with a multi-heat source heat pump of claim 1, wherein the regulating use of various heat sources through a heat storage integrated regulation system in the step c comprises:
setting all of the flow area of the water collecting pipe pₛ, the effective gas collecting area of the gas collecting pipe pₖ and the effective heat collecting area of the solar panel p_{d} to ½ of a maximum value in an initial state;
in response to the hourly heat storage capacity Q_{rb}<1.45Qₜₒₗ, comparing the magnitudes of ζₛ, ζₖ, and ζ_{d} at that time, reducing a collecting area of a heat source with the minimum heat storage efficiency to 40% of the original level, increasing a collecting area of a heat source with the maximum heat storage efficiency to 120% of the original level, recalculating the hourly heat storage capacity Q_{rb}, and comparing the hourly heat storage capacity Q_{rb} with the hourly total heat consumption of the system Qₜₒₗ;
in response to the hourly heat storage capacity Q_{rb} is still less than 1.45Qₜₒₗ, regulating the flow area of the water collecting pipe pₛ, the effective gas collecting area of the gas collecting pipe pₖ, and the effective heat collecting area of the solar panel p_{d} through a PID-based control algorithm, so that a heat storage of the heat pump for each hour finally satisfies the hourly heat storage capacity Q_{rb}=1.45Qₜₒₗ.

4. The control method for the phase-change energy storage type cold and heat combined supply system with a multi-heat source heat pump of claim 3, wherein the regulating the flow area of the water collecting pipe pₛ, the effective gas collecting area of the gas collecting pipe pₖ, and the effective heat collecting area of the solar panel p_{d} through PID-based control algorithm comprises:
taking the flow area of the water collecting pipe pₛ, the effective gas collecting area of the gas collecting pipe pₖ, and the effective heat collecting area of the solar panel p_{d} as control variables and the hourly heat storage capacity Q_{rb} as an output variable, and each sampling time is set to one hour, then at the k^{th} hour, the difference 1.45Qₜₒₗ−Q_{rb}(k) between a target value of the output 1.45Qₜₒₗ and the heat storage capacity of the heat pump Q_{rb}(k) at the k^{th} hour is called deviation e(k), and continuously adjusting the magnitude of pₛ, pₖ, and p_{d} by using the following formula, so that the hourly heat storage capacity of the heat pump Q_{rb} is finally equal to 1.45Qₜₒₗ that after multiple iterations:
$${Q}_{rb} = {K}_{p} e ( k ) + {K}_{i} {\sum }_{n = 0}^{k} e ( n ) + {K}_{d} ( e ( k ) - e ( k - 1 ) ) ;$$
wherein Kₚ is a proportion coefficient, and taking 0.5pₛ; Kᵢ is an integral time constant, and taking 0.7pₖ; K_{d} is a differential time constant, taking 0.65p_{d} and e(0)=0.

5. The control method for the phase-change energy storage type cold and heat combined supply system with a multi-heat source heat pump of claim 1, wherein the phase change material is a mixed material of industrial-grade acetamide and natural renewable grease.

6. A control device for a phase-change energy storage type cold and heat combined supply system with a multi-heat source heat pump, being configured to execute the control method for the phase-change energy storage type cold and heat combined supply system with a multi-heat source heat pump of claim 1, comprising an acquisition and detection module, a control module, a modulation algorithm module, an integrated compensation module and a heat pump and cold and heat combined supply system,
wherein the acquisition and detection module is configured to execute speed acquisition, temperature acquisition, and thermal energy acquisition, and transmit a acquired data to the control module;
wherein the modulation algorithm module is connected to the control module, and
configured to analyze the acquired data by the acquisition and detection module and calculate to obtain the hourly heat storage capacity of the heat pump Q_{rb};
wherein the integrated compensation module is connected to the control module, and connected to the heat pump and the cold and heat combined supply system together with the control module;
wherein the operation steps are as follows:
a. detecting various indexes of wind speed, water flow rate, air temperature, water temperature, and geothermal temperature by electric detection of the acquisition and detection module, and transmitting the data to the control module;
b. analyzing the acquired data using the control module through the modulation algorithm module, and at the same time controlling the integrated compensation module to adjust the collecting area of various types of heat sources; and
c. sending a regulation instruction to the heat pump to complete optimization and control of the cold and heat combined supply system.
